(19) United States
(12) Patent Application Publication
(10) Pub. No.: US 2017/0099660 A1
(43) Pub. Date: Apr. 6, 2017

(54) METHOD AND APPARATUS FOR TRANSMITTING UPLINK DATA

(71) Applicant: ELECTRONICS AND TELECOMMUNICATIONS RESEARCH INSTITUTE, Daejeon (KR)

(72) Inventor: Sung-Min OH, Daejeon (KR)

(73) Assignee: ELECTRONICS AND TELECOMMUNICATIONS RESEARCH INSTITUTE, Daejeon (KR)

(21) Appl. No.: 15/283,397

(22) Filed: Oct. 1, 2016

(30) Foreign Application Priority Data
Oct. 1, 2015 (KR) 2015-0138665
Jul. 19, 2016 (KR) 2016-0091646

(51) Int. Cl. H04W 72/04; H04W 76/04; H04L 5/00; H04W 74/08

(52) U.S. Cl. CPC H04W 72/0413; H04W 74/0833; H04W 76/046; H04W 72/042; H04L 5/0055

(57) ABSTRACT

A wireless terminal selects a first random access preamble in a random access preamble group for a small-sized data transmission (SDT) and transmits the selected first random access preamble to a base station, if a size of a data packet to be transmitted is smaller than a maximum SDT size set for the SDT and receives a random access response message including a first uplink resource from the base station. Further, the wireless terminal transmits the data packet using the first uplink resource without an RRC connection setup with the base station.

### CROSS-REFERENCE TO RELATED APPLICATION

This application claims priority to and the benefit of Korean Patent Application Nos. 10-2015-0138665 and 10-2016-0091646 filed in the Korean Intellectual Property Office on Oct. 1, 2015 and Jul. 19, 2016, the entire contents of which are incorporated herein by reference.

### BACKGROUND OF THE INVENTION

(a) Field of the Invention

The present invention relates to a method and an apparatus for transmitting uplink data, and more particularly, to a technology of transmitting uplink data capable of reducing a signaling overhead in a cellular communication system.

(b) Description of the Related Art

Most of wireless terminals expected to be applied to services such as a smart meter, home automation, e-Health, and an environment sensing sensor have intermittently transmitted small-sized data. However, the existing cellular communication system is appropriately designed for voice communication continuously transmitting data, web browsing, multimedia services, or the like once a session is connected to a mobile terminal. As a result, a signaling overhead problem of the terminal intermittently transmitting the small-sized data in a cellular communication system may occur as follows.

In existing cellular communication system, the terminal is changed to an idle state if the terminal does not transmit data for a predetermined time (user inactivity timer). Here, the idle state means a radio resource control (RRC)-idle and an evolved packet system (EPS) connection management (ECM)-idle. In the idle state, a data radio bearer (DRB) and an S1 bearer are released on a user plane and an RRC connection and an S1 signaling connection are released on a control plane.

When the existing cellular communication system intermittently transmits the small-sized data, the wireless terminal is highly likely to transmit data in the idle state. Therefore, the wireless terminal involves an operation procedure for again setting a bearer and control connection that are released to transmit data. As a result, when a size of the data transmitted by the wireless terminals is as small as tens to hundreds of bytes, the operation procedure for transmitting data in the idle state may be very inefficient.

### SUMMARY OF THE INVENTION

The present invention has been made in an effort to provide a method and an apparatus for transmitting uplink data having advantages of reducing a signaling overhead when a terminal in an idle state intermittently transmits small-sized data in a cellular communication system.

An exemplary embodiment of the present invention provides a method for transmitting, by a wireless terminal, uplink data. The method includes: selecting a first random access preamble in a random access preamble group for a small-sized data transmission (SDT) and transmitting the selected first random access preamble to a base station, if a size of a data packet to be transmitted is smaller than a maximum SDT size set for the SDT; receiving a random access response message including a first uplink resource from the base station; and transmitting the data packet using the first uplink resource without a radio resource control (RRC) connection setup with the base station.

The method may further include: selecting a second random access preamble from the remaining random access preambles other than the random access preamble group for the SDT and transmitting the selected second random access preamble to the base station, if the size of the data packet to be transmitted is larger than the maximum SDT size; receiving a random access response message including a second uplink resource from the base station; and performing the RRC connection setup with the base station using the second uplink resource.

The transmitting of the data packet may include: generating a scramble sequence using an SDT common identifier commonly allocated to terminals for the SDT or an SDT dedicated identifier allocated to distinguish the terminals for the SDT; and scrambling the data packet using the scramble sequence.

The method may further include: receiving a system information block including the maximum SDT size, the SDT common identifier, and the random access preamble group for the SDT from the base station.

The method may further include: transmitting information that the wireless terminal is an SDT possible terminal to the base station; and receiving an SDT dedicated identifier allocated to the wireless terminal from the base station.

The transmitting of the information that the wireless terminal is the SDT possible terminal may include: setting the information that the wireless terminal is the SDT possible terminal in an establishment cause field included in an RRC connection request message; and transmitting the RRC connection request message and the receiving of the SDT dedicated identifier may include receiving an RRC connection setup message including the SDT dedicated identifier from the base station.

The transmitting of the data packet may include transmitting the SDT dedicated identifier along with the data packet.

The method may further include: receiving a downlink packet including ACK information on the data packet and the SDT dedicated identifier from the base station.

The receiving of the downlink packet may include: receiving a downlink control channel encoded using an SDT common identifier commonly allocated to terminals for the SDT from the base station; confirming a resource location of the downlink packet by decoding the downlink control channel using the SDT common identifier; and receiving the downlink packet at the resource location.

The method may further include: performing a random access preamble retransmission procedure if the downlink packet is not received until a set timer expires after the data packet is transmitted.

The method may further include: performing a random access preamble retransmission procedure if the random access response message is not received until the set timer expires after the first random access preamble is transmitted.

Another embodiment of the present invention provides an apparatus for transmitting, by a wireless terminal, uplink data. The apparatus for transmitting uplink data includes a transceiver and a processor. The transceiver may communicate with a base station. The processor may select a first random access preamble in a random access preamble group for a small-sized data transmission (SDT) and transmit the selected first random access preamble through the transceiver if a size of a data packet to be transmitted is smaller than a maximum SDT size set for the SDT and transmit the data packet through the transceiver without an RRC connection setup with the base station using an uplink resource in a random access response message corresponding to the first random access preamble received from the base station.

The processor may select a second random access preamble from the remaining random access preambles other than the random access preamble group for the SDT and transmit the selected second random access preamble through the transceiver when the size of the data packet to be transmitted is larger than the maximum SDT size and perform the RRC connection setup with the base station using an uplink resource in a random access response message corresponding to the second random access preamble received from the base station.

The processor may generate a scramble sequence using an SDT common identifier commonly allocated to terminals for the SDT or an SDT dedicated identifier allocated to distinguish the terminals for the SDT and scramble the data packet using the scramble sequence.

The transceiver may receive a system information block from the base station and the system information block may include at least one of the maximum SDT size, the SDT common identifier, and the random access preamble group for the SDT.

The processor may transmit information that the wireless terminal is an SDT possible terminal through the transceiver and may be allocated an SDT dedicated identifier for an SDT possible wireless terminal from the base station.

The processor may generate a first media access control protocol data unit (MAC PDU) including the SDT dedicated identifier and the data packet and transmit the first MAC PDU through the transceiver.

The transceiver may receive a second MAC PDU including confirmation information for the data packet and the SDT dedicated identifier from the base station and the processor may use the SDT dedicated identifier included in the second MAC PDU to confirm whether the second MAC PDU is transmitted to the wireless terminal.

The apparatus may further include: a memory storing the SDT dedicated identifier, in which the processor may use the SDT dedicated identifier for the SDT when the wireless terminal is in an idle state.

The processor may perform a random access preamble retransmission procedure if the processor does not receive confirmation information for the data packet from the base station until a set first timer expires after the data packet is transmitted or if the processor does not receive the random access response message until the set first timer expires after the first random access preamble is transmitted.

### BRIEF DESCRIPTION OF THE DRAWINGS

FIG. 1 is a diagram illustrating a procedure of transmitting uplink data according to an exemplary embodiment of the present invention.

FIG. 2 is a flow chart illustrating a method for transmitting, by a wireless terminal illustrated in FIG. 1, uplink data.

FIG. 3 is a diagram illustrating a method for allocating an SDT dedicated identifier according to an exemplary embodiment of the present invention.

FIG. 4 is a diagram illustrating a wireless terminal and a base station according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout the present specification and claims, unless explicitly described to the contrary, “comprising” any components will be understood to imply the inclusion of other elements rather than the exclusion of any other elements.

Throughout the specification, a wireless terminal may refer to a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and the like and may also include all or some of the functions of the MT, the MS, the AMS, the HR-MS, the SS, the PSS, the AT, the UE, and the like.

Further, the base station (BS) may be called an advanced base station (ABS), a high reliability base station (HR-BS), a node B, an evolved node B (eNodeB), an access point (AP), a radio access station (RAS), a base transceiver station (BTS), a mobile multihop relay (MMR)-BS, a relay station (RS) serving as a base station, a relay node (RN) serving as a base station, an advanced relay station (ARS) serving as a base station, a high reliability relay station (HR-RS) serving as a base station, small base stations (a femto base station (femto BS), a home node B (HNB), a home eNodeB (HeNB), a pico base station (pico BS), a metro base station (metro BS), a micro base station (micro BS), and the like), and the like and may also include all or some of the functions of the ABS, the HR-BS, the node B, the eNodeB, the AP, the RAS, the BTS, the MMR-BS, the RS, the RN, the ARS, the HR-RS, the small base stations, and the like.

Hereinafter, a method and an apparatus for transmitting uplink data according to an exemplary embodiment of the present invention will be described in detail with the accompanying drawings.

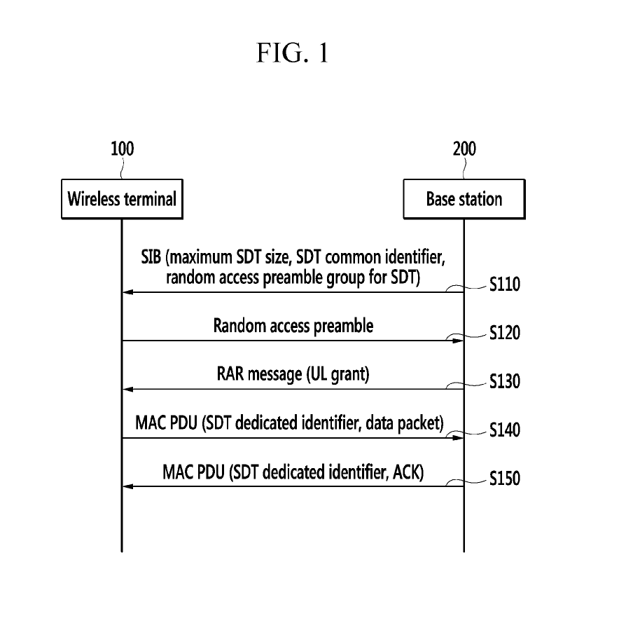

FIG. 1 is a diagram illustrating a procedure of transmitting uplink data according to an exemplary embodiment of the present invention.

Referring to FIG. 1, a base station 200 transmits parameters associated with a small-sized data transmission (SDT) to wireless terminals 100 through a system information block (SIB) (S110). The parameters associated with the SDT may include a maximum SDT size, an SDT common identifier, and random access preamble group information for the SDT. Here, the maximum SDT size is used to distinguish whether data to be transmitted by the wireless terminals 100 are small-sized data. The SDT common identifier means an identifier that is commonly used by the terminals transmitting the small-sized data. When the wireless terminal 100 transmits the uplink data, the SDT common identifier is used instead of a cell radio network temporary identifier (C-RNTI) that is used to generate a scramble sequence and when the base station 200 transmits acknowledgement (ACK) for the uplink data transmission to a downlink, the SDT common identifier is used to encode and decode a physical downlink control channel (PDCCH). A random access preamble group for the SDT is used to notify the base station 200 that the wireless terminal 100 transmits the small-sized data. Here, the random access preamble group for the SDT means a part of the entire random access preamble index and is defined to be used only at the time of the small-sized data transmission.

When a data packet to be transmitted in an idle state is generated, if a size of the data packet to be transmitted is larger than a maximum SDT size, the wireless terminal 100 randomly selects one random access preamble from the remaining random access preambles other than the random access preamble group for the SDT and transmits the selected random access preamble to the base station 200. In this case, the base station 200 sets an uplink grant (UL grant) in a random access response (RAR) message so that the wireless terminal 100 may transmit a radio resource control (RRC) connection request message to an uplink and transmits the set uplink grant to the wireless terminal 100.

Generally, when receiving the RAR message, the wireless terminal 100 performs an RRC connection setup procedure. In detail, the wireless terminal 100 transmits the RRC connection request message to the base station 200 through allocated resources in the uplink grant of the PAR message. Further, the base station 200 generates the RRC connection setup message and transmits the generated RRC connection setup message to the wireless terminal 100. In this case, the base station 200 may transmit the uplink grant and a UE contention resolution identifier to the wireless terminal 100 through the RRC connection setup message. The uplink grant in the RRC connection setup message includes resource allocation information for transmitting an RRC connection complete message. The wireless terminal 100 includes the data packet in the RRC connection complete message and transmits the RRC connection complete message to the base station 200 through the uplink resource allocated through the UL grant. As such, the wireless terminal 100 performs the RRC connection setup procedure with the base station 200 after the random access procedure.

Unlike this, according to the exemplary embodiment of the present invention, the wireless terminal 100 may transmit a small-sized data packet without the RRC connection setup procedure if the size of the data packet to be transmitted in the idle state is smaller than the maximum SDT size.

More specifically, if the size of the data packet to be transmitted is smaller than the maximum SDT size, the wireless terminal 100 randomly selects one random access preamble from the random access preambles in the random access preamble group for the SDT and transmits the selected random access preamble to the base station 200 (S120). FIG. 1 illustrates only the procedure of transmitting an uplink data if the size of the data packet to be transmitted is smaller than the maximum SDT size.

The base station 200 receiving the random access preamble in the random access preamble group for the SDT sets the UL grant in the RAR message so that the wireless terminal 100 may directly transmit the corresponding data packet and transmits the set UL grant to the wireless terminal 100 (S130).

The wireless terminal 100 for receiving the RAR transmits a media access control protocol data unit (MAC PDU) including the data packet to the base station 200 through the uplink resources allocated in the UL grant (S140). In this case, the wireless terminal 100 may use an SDT common identifier or an SDT dedicated identifier (ID) received through the SIB message instead of the C-RNTI to generate a scramble sequence and may scramble the MAC PDU using the scramble sequence and transmit the scrambled MAC PDU to the base station 200. Here, the SDT dedicated identifier may be allocated from the base station 200 or changed during at least one of an initial attach process, a cell reselection process, and a tracking area update (TAU) process and may also be allocated from the base station through the RRC connection setup process when the SDT dedicated identifier needs to be allocated or changed. The SDT dedicated identifier is an identifier used to distinguish the wireless terminals 100 transmitting the small-sized data separately from the C-RNTI. As the SDT dedicated identifier, a unique identifier in a cell may be allocated and used and SAE-temporary mobile subscriber identity (S-TMSI) may be used. The SDT dedicated identifier is stored in the wireless terminal 100 and the base station 200 as it is even when the wireless terminal 100 is changed to the idle state and then is used when the wireless terminal 100 transmits the small-sized data in the idle state.

The wireless terminal 100 may include the SDT dedicated identifier allocated from the base station 200 in a header of the MAC PDU, generate the scramble sequence using the SDT dedicated identifier, and scramble the MAC PDU using the scramble sequence and transmit the scrambled MAC PDU to the base station 200.

As such, according to the exemplary embodiment of the present invention, the wireless terminal 100 may directly transmit the data packet using the uplink resources in the RAR without the bearer setup and the RRC connection setup process when intermittently transmitting the small-sized data, thereby reducing the signaling overhead.

To transmit the ACK information to the wireless terminal 100, the base station 200 receiving the MAC PDU generates the MAC PDU that includes the SDT dedicated identifier of the wireless terminal 100 transmitted through the MAC PDU and the ACK and transmits the generated MAC PDU to the corresponding wireless terminal 100 (S150). The base station 200 may generate the scramble sequence using the SDT dedicated identifier and scramble the MAC PDU using the scramble sequence and transmit the scrambled MAC PDU to the wireless terminal 100. In this case, the base station 200 transmits location information on a downlink resource, which transmits the MAC PDU to the wireless terminal 100 through the PDCCH, to the wireless terminal 100. The base station 200 may encode the PDCCH using the SDT common identifier and transmit the encoded PDCCH to the wireless terminal 100.

The wireless terminal 100 transmitting the small-sized data packet monitors the PDCCH using the SDT common identifier and decodes the PDCCH if there is the PDCCH of the corresponding SDT common identifier.

The wireless terminal 100 decodes the MAC PDU using the SDT common identifier or the SDT dedicated identifier at the location of the downlink resource specified to the corresponding PDCCH. When decoding the MAC PDU using the SDT common identifier, the wireless terminal 100 confirms the SDT dedicated identifier in the MAC PDU to differentiate whether the MAC PDU is the MAC PDU transmitted to the wireless terminal 100.

The wireless terminal 100 drops the corresponding MAC PDU if the SDT dedicated identifier in the MAC PDU is different from the SDT dedicated identifier in its own MAC PDU. When decoding the MAC PDU using the SDT dedicated identifier, the wireless terminal 100 recognizes the corresponding MAC PDU as the MAC PUD transmitted thereto when the decoding succeeds.

The wireless terminal 100 may retransmit the random access preamble in the following case. When the wireless terminal 100 transmits the random access preamble and does not receive the RAR message until timer 1 expires, the wireless terminal 100 may retransmit the random access preamble. When the wireless terminal 100 transmits the MAC PDU and does not receive the MAC PDU including its own SDT dedicated identifier and the ACK, the wireless terminal 100 may retransmit the random access preamble.

If a number of retransmissions or a current data packet transmission is smaller than a maximum number of retransmissions, the wireless terminal 100 may retransmit the random access preamble. If the number of retransmissions for a current data packet transmission is more than the maximum number of retransmissions, the wireless terminal 100 may drop the corresponding data packet and stop the data transmission operation procedure.

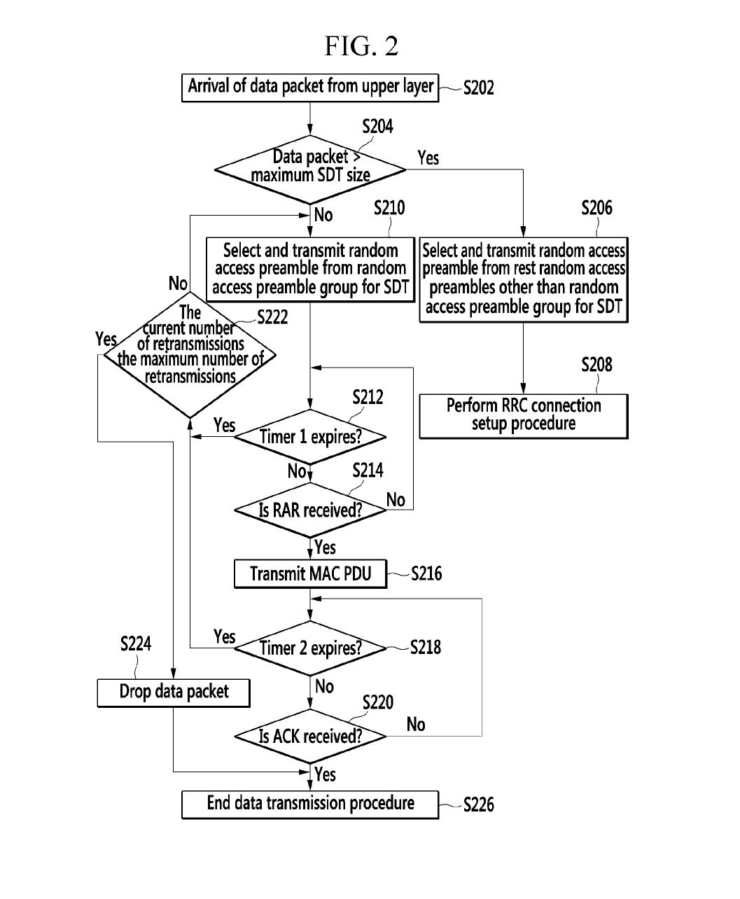

FIG. 2 is a flow chart illustrating a method for transmitting, by a wireless terminal illustrated in FIG. 1, uplink data.

Referring to FIG. 2, if a data packet to be transmitted from an upper layer arrives (S202), the wireless terminal 100 confirms whether the size of the data packet to be transmitted is larger than the maximum SDT size (S204).

If the size of the data packet to be transmitted is larger than the maximum SDT size, the wireless terminal 100 randomly selects one random access preamble from the remaining random access preambles other than the random access preamble group for the SDT and transmits the selected random access preamble to the base station (S206). Further, the wireless terminal 100 receives the RAR message and then performs the existing procedure for the uplink data transmission, for example, the RRC connection setup procedure (S208).

On the other hand, if the size of the data packet to be transmitted is smaller than the maximum SDT size, the wireless terminal 100 randomly selects one random access preamble from the random access preambles in the random access preamble group for the SDT and transmits the selected random access preamble to the base station 200 (S210).

The wireless terminal 100 transmitting the random access preamble drives the timer 1. Further, the wireless terminal 100 waits to receive the RAR message from the base station 200 until the timer 1 expires.

If the wireless terminal 100 receives the RAR message from the base station 200 before the timer 1 expires (S212 and S214), the wireless terminal 100 uses the uplink resource allocated through the RAR message to transmit the MAC PDU including the data packet to the base station 200 (S216).

The wireless terminal 100 transmitting the MAC PDU drives timer 2. Further, the wireless terminal 100 waits to receive the MAC PDU including the SDT dedicated identifier of the wireless terminal 100 and the ACK from the base station 200 until the timer 2 expires.

If the wireless terminal 100 receives the MAC PDU from the base station 200 before the timer 2 expires (S218 and S220), the wireless terminal 100 ends a data transmission procedure (S226).

On the other hand, when the wireless terminal 100 does not receive the RAR message until the timer 1 expires or does not receive the MAC PDU including the SDT dedicated identifier of the wireless terminal 100 and the ACK until the timer 2 expires, the wireless terminal 100 may retransmit the random access preamble.

If the number of retransmissions for the current data packet transmission is smaller than the maximum number of retransmissions (S222), the wireless terminal 100 may perform the processes from the step S210 again.

However, if the number of retransmissions for the current data packet transmission is more than the maximum number of retransmissions, the wireless terminal 100 may drop the corresponding data packet (S224) and end the data transmission operation procedure (S226).

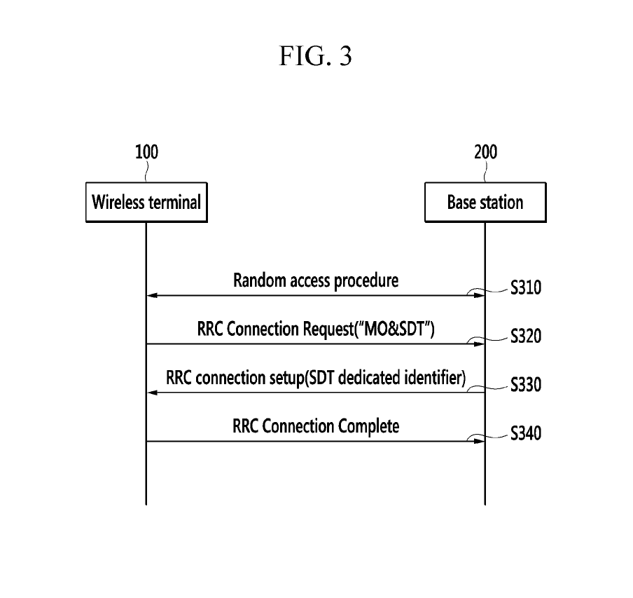

FIG. 3 is a diagram illustrating a method for allocating an SDT dedicated identifier according to an exemplary embodiment of the present invention.

Referring to FIG. 3, transmitting, by the wireless terminal 100, the small-sized data packet may be set according to the following method.

The wireless terminal 100 sets the SDT according to an application layer service. For example, when an application layer service is a smarter meter, the wireless terminal 100 transmits application layer information to an RRC layer through a primitive at an application layer. Alternatively, the SDT may be set using header information such as a port number and an IP address transmitted from the upper layer. Unlike this, a user may set the SDT in the corresponding wireless terminal 100.

The so set wireless terminal 100 is registered in the corresponding network through an initial attach process. The wireless terminal 100 performs the random access procedure in the initial attach process (S310) and then notifies the base station 200 that the wireless terminal 100 is an SDT possible terminal based on an establishment cause field among information elements (IEs) of the RRC connection request message (S320). For example, the wireless terminal 100 may set the establishment cause field as “Mobile-Originated (MO) & SDT” to notify the base station 200 of the information that the wireless terminal 100 is the SDT possible terminal.

The base station 200 receiving the RRC connection request message in which the “Mobile-Originated (MO) & SDT” is set allocates the SDT dedicated identifier to the wireless terminal 100 and transmits the SDT dedicated identifier to the wireless terminal 100 by including the SDT dedicated identifier in the RRC connection setup message (S330). In this case, the base station 200 may further include common parameters required for the SDT such as the SDT common identifier in the RRC connection setup message.

The wireless terminal 100 confirms the SDT dedicated identifier in the RRC connection setup message and stores and manages the SDT dedicated identifier.

The wireless terminal 100 transmits an RRC connection complete message to the base station 200 (S340).

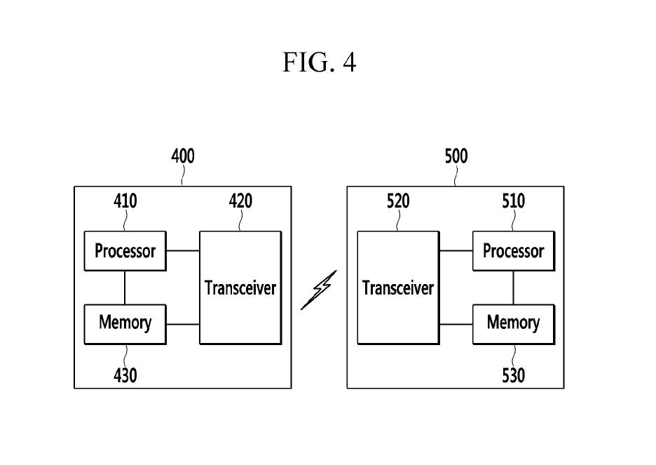

FIG. 4 is a diagram illustrating a wireless terminal and a base station according to an exemplary embodiment of the present invention.

Referring to FIG. 4, a wireless terminal 400 for transmitting uplink data includes a processor 410, a transceiver 420, and a memory 430.

The processor 410 may be implemented to perform the procedure, the method, and the function performed by the wireless terminal described with reference to FIGS. 1 to 3.

The transceiver 420 is connected to the processor 410 to transmit and receive a wireless signal to and from the base station 200.

The memory 430 stores instructions which are performed by the processor 410 or loads instructions from a storage device (not illustrated) and temporarily stores the instructions and the processor 410 may execute the instructions which are stored or loaded in the memory 430. Further, the memory 430 may store information required to allow the processor 410 to perform the procedure, the method, and the function performed by the wireless terminal 100 described with reference to FIGS. 1 to 3.

The processor 410 and the memory 430 are connected to each other through a bus (not illustrated) and an input/output interface (not illustrated) may also be connected to the bus. In this case, the transceiver 420 is connected to the input/output interface and peripheral devices such as an input device, a display, a speaker, and a storage device may be connected to the input/output interface.

A base station 500 communicating with the wireless terminal (100 of FIG. 1) includes a processor 510, a transceiver 520, and a memory 530.

The processor 510 may be implemented to perform the procedure, the method, and the function performed by the base station described with reference to FIGS. 1 to 3.

The transceiver 520 is connected to the processor 510 to transmit and receive a wireless signal to and from the wireless terminal 100.

The memory 530 stores instructions which are performed by the processor 510 or loads instructions from a storage device (not illustrated) and temporarily stores the instructions and the processor 510 may execute the instructions which are stored or loaded in the memory 530. Further, the memory 530 may store information required to allow the processor 510 to perform the procedure, the method, and the function performed by the base station described with reference to FIGS. 1 to 3.

The processor 510 and the memory 530 are connected to each other through a bus (not illustrated) and an input/output interface (not illustrated) may also be connected to the bus. In this case, the transceiver 520 is connected to the input/output interface and peripheral devices such as an input device, a display, a speaker, and a storage device may be connected to the input/output interface.

According to an embodiment of the present invention, it is possible to reduce the signaling overhead that may occur when the wireless terminals intermittently transmit data in the existing cellular communication system.

Further, it is possible to improve the efficiency of the data transmission resources and increase the number of wireless terminals that may be supported with the limited resources.

The exemplary embodiments of the present invention are not implemented only by the apparatus and/or method as described above, but may be implemented by programs realizing the functions corresponding to the configuration of the exemplary embodiments of the present invention or a recording medium recorded with the programs, which may be readily implemented by a person having ordinary skill in the art to which the present invention pertains from the description of the foregoing exemplary embodiments.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method for transmitting, by a wireless terminal, uplink data, comprising:
selecting a first random access preamble in a random access preamble group for a small-sized data transmission (SDT) and transmitting the selected first random access preamble to a base station, if a size of a data packet to be transmitted is smaller than a maximum SDT size set for the SDT;
receiving a random access response message including a first uplink resource from the base station; and
transmitting the data packet using the first uplink resource without a radio resource control (RRC) connection setup with the base station.

2. The method of claim 1, further comprising:
selecting a second random access preamble from the remaining random access preambles other than the random access preamble group for the SDT and transmitting the selected second random access preamble to the base station, if the size of the data packet to be transmitted is larger than the maximum SDT size;
receiving a random access response message including a second uplink resource from the base station; and
performing the RRC connection setup with the base station using the second uplink resource.

3. The method of claim 1, wherein:
the transmitting of the data packet includes:
generating a scramble sequence using an SDT common identifier commonly allocated to terminals for the SDT or an SDT dedicated identifier allocated to distinguish the terminals for the SDT; and
scrambling the data packet using the scramble sequence.

4. The method of claim 3, further comprising:
receiving a system information block including the maximum SDT size, the SDT common identifier, and the random access preamble group for the SDT from the base station.

5. The method of claim 1, further comprising:
transmitting information that the wireless terminal is an SDT possible terminal to the base station; and
receiving an SDT dedicated identifier allocated to the wireless terminal from the base station.

6. The method of claim 5, wherein:
the transmitting of the information that the wireless terminal is the SDT possible terminal includes:
setting the information that the wireless terminal is the SDT possible terminal in an establishment cause field included in an RRC connection request message; and
transmitting the RRC connection request message, and
the receiving of the SDT dedicated identifier includes receiving an RRC connection setup message including the SDT dedicated identifier from the base station.

7. The method of claim 5, wherein:
the transmitting of the data packet includes transmitting the SDT dedicated identifier along with the data packet.

8. The method of claim 7, further comprising:
receiving a downlink packet including ACK information on the data packet and the SDT dedicated identifier from the base station.

9. The method of claim 8, wherein:
the receiving of the downlink packet includes:
receiving a downlink control channel encoded using an SDT common identifier commonly allocated to terminals for the SDT from the base station;
confirming a resource location of the downlink packet by decoding the downlink control channel using the SDT common identifier; and
receiving the downlink packet at the resource location.

10. The method of claim 8, further comprising:
performing a random access preamble retransmission procedure if the downlink packet is not received until a set timer expires after the data packet is transmitted.

11. The method of claim 1, further comprising:
performing a random access preamble retransmission procedure if the random access response message is not received until a set timer expires after the first random access preamble is transmitted.

12. An apparatus for transmitting, by a wireless terminal, uplink data, comprising:
a transceiver communicating with a base station; and
a processor selecting a first random access preamble in a random access preamble group for a small-sized data transmission (SDT) and transmitting the selected first random access preamble through the transceiver if a size of a data packet to be transmitted is smaller than a maximum SDT size set for the SDT and transmitting the data packet through the transceiver without an RRC connection setup with the base station using an uplink resource in a random access response message corresponding to the first random access preamble received from the base station.

13. The apparatus of claim 12, wherein:
the processor selects a second random access preamble from the remaining random access preambles other than the random access preamble group for the SDT and transmits the selected second random access preamble through the transceiver when the size of the data packet to be transmitted is larger than the maximum SDT size and performs the RRC connection setup with the base station using an uplink resource in a random access response message corresponding to the second random access preamble received from the base station.

14. The apparatus of claim 12, wherein:
the processor generates a scramble sequence using an SDT common identifier commonly allocated to terminals for the SDT or an SDT dedicated identifier allocated to distinguish the terminals for the SDT and scrambles the data packet using the scramble sequence.

15. The apparatus of claim 14, wherein:
the transceiver receives a system information block from the base station, and
the system information block includes at least one of the maximum SDT size, the SDT common identifier, and the random access preamble group for the SDT.

16. The apparatus of claim 12, wherein:
the processor transmits information that the wireless terminal is an SDT possible terminal through the transceiver and is allocated an SDT dedicated identifier for an SDT possible wireless terminal from the base station.

17. The apparatus of claim 16, wherein:
the processor generates a first media access control protocol data unit (MAC PDU) including the SDT dedicated identifier and the data packet and transmits the first MAC PDU through the transceiver.

18. The apparatus of claim 17, wherein:
the transceiver receives a second MAC PDU including confirmation information for the data packet and the SDT dedicated identifier from the base station, and
the processor uses the SDT dedicated identifier included in the second MAC PDU to confirm whether the second MAC PDU is transmitted to the wireless terminal.

19. The apparatus of claim 16, further comprising:
a memory storing the SDT dedicated identifier,
wherein the processor uses the SDT dedicated identifier for the SDT when the wireless terminal is in an idle state.

20. The apparatus of claim 12, wherein:
the processor performs a random access preamble retransmission procedure if the processor does not receive confirmation information for the data packet from the base station until a set first timer expires after the data packet is transmitted or if the processor does not receive the random access response message until the set first timer expires after the first random access preamble is transmitted.
